(19) United States
(12) Patent Application Publication
(10) Pub. No.: US 2003/0064647 A1
(43) Pub. Date: Apr. 3, 2003

(54) Tarpaulin using resin composition for press-coating and method for preparing the same

(75) Inventor: Dong-ho Chang, Seoul (KR)

Correspondence Address: HAHN LOESER & PARKS, LLP, TWIN OAKS ESTATE, 1225 W. MARKET STREET, AKRON, OH, 44313, US

(73) Assignee: Korea Tarpaulin Co., Ltd.

(21) Appl. No.: 10/010,544

(22) Filed: Nov. 5, 2001

(30) Foreign Application Priority Data
May 30, 2001 (KR) 2001-29924

(51) Int. Cl. B32B 27/32; B32B 27/12

(52) U.S. Cl. 442/290

(57) ABSTRACT

The present invention relates to a tarpaulin using resin composition for press-coating and a preparation method thereof. The tarpaulin comprises a polypropylene woven fabric layer prepared by weaving polypropylene multifilament yarn; and a resin composition layer which is press-coated on either or both sides of said polypropylene woven fabric layer, wherein the resin composition is obtained by melt-kneading ethylene-propylene copolymer and ethylene-octene random copolymer or styrene-ethylene-butene block copolymer. The tarpaulin of the present invention as obtained by using a resin composition for press-coating is flexible, light and recyclable. Because the tarpaulin of the present invention has an excellent mechanical strength, it is suitable for use as an industrial material.

### FIELD OF THE INVENTION

The present invention relates to a tarpaulin using resin composition for press-coating and a preparation method thereof. More particularly, the present invention is directed to a method for preparing tarpaulin by using a resin composition for press-coating obtained by melt-kneading ethylene-propylene copolymer and ethylene-octene random copolymer or styrene-ethylene-butene block copolymer, which method enables to obtain a tarpaulin having excellent flexibility and light-weight, as well as being reusable by which an environmental problem is not raised, in order to provide a new tarpaulin which can replace the prior art tarpaulin made from PVC resin and PE resin, and a tarpaulin produced by such method.

### DESCRIPTION OF THE PRIOR ART

A tarpaulin which is widely used as a packaging cover, architectural protective film, etc. has been prepared by coating the both sides of polyester cotton yarn with a PVC resin.

As shown in FIG. 1, according to a conventional process for producing tarpaulin, a polyester cotton yarn is woven as a core element and the obtained polyester woven fabric 1 is transported by a conveyer to initiate a lamination of a PVC resin sent from a hopper 2 on nylon woven fabric 1. PVC resin 4 supplied on the polyester woven fabric 1 is passed through an extruder 3 consisting of a cooling roller and a pressing roller to be melt-fused to form a PVC resin layer, while the same PVC resin 4 is also coated on the opposite side of the polyester woven fabric 1 to obtain a tarpaulin.

Thusly obtained PVC tarpaulin has been widely used as an industrial material because of its excellent flexibility at a low temperature as well as a high mechanical strength.

However, this prior art tarpaulin has many problems in that due to its high density, a product made therefrom has a heavy weight, and an environmental hormone-inducing agent is used during its preparation method. Particularly, dioxine, a lethal hormone to environment is produced in a large amount during incineration.

On the other hand, a polyethylene tarpaulin which is produced by using high-density polyethylene and low-density polyethylene instead of polyester woven fabric and PVC resin, respectively, of said PVC tarpaulin has advantages over the PVC tarpaulin in that it is light, and no harmful agent to an environment is used in its preparation, and is recyclable. But a product made therefrom with a same thickness as that of the PVC tarpaulin, has lower flexibility and poorer mechanical strength than that made from PVC tarpaulin and thus, it is impossible to use the product made therefrom as an industrial materials, and the use thereof is extremely restricted, accordingly.

### SUMMARY OF THE INVENTION

The present inventors have intensively investigated to resolve the aforementioned problems of the prior art and found that such object can be achieved with a tarpaulin prepared from a resin composition for press-coating obtained by melt-kneading ethylene-propylene copolymer and ethylene-octene random copolymer or styrene-ethylene-butene block copolymer. The present invention is based on such finding.

Therefore, an object of the present invention is to provide a tarpaulin which is flexible, able to make a light-weight product therefrom, and is recyclable so as not to raise harmful influence to environment, while having comparable mechanical intensity compared to the prior art PVC tarpaulin so as to be useful as an industrial material.

Another object of the present invention is to provide a method for preparing the aforementioned tarpaulin.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

Other objects and aspects of the present invention will become apparent from the following description of embodiments with reference to the accompanying drawing in which:

FIG. 1 is a schematic view showing a conventional process for preparing tarpaulin.

FIG. 2 shows a structure of the tarpaulin according to the present invention.

### DESCRIPTION OF THE PREFERRED EMBODIMENTS

With the reference to FIG. 2, an object of the present invention is achieved by providing a tarpaulin comprising a polypropylene woven fabric layer 10 made by weaving polypropylene multifilament yarn and a resin layer for press-coating 12 and 14 which is press-coated on either or both sides of said polypropylene woven fabric layer, obtained by melt-kneading ethylene-propylene copolymer and ethylene-octene random copolymer or styrene-ethylene-butene block copolymer.

The detailed description of the present invention is provided hereinafter.

In the present invention, the resin composition for press coating is used instead of PVC, PE resin of the prior art, in order to provide a tarpaulin which is flexible, able to make a light-weight product therefrom, and is recyclable so as not to raise harmful influence to environment, while having comparable mechanical intensity compared to the prior art PVC tarpaulin so as to be useful as an industrial material.

The resin composition for press coating used in the present invention is obtained by melt-kneading (A) ethylene-propylene copolymer and (B) ethylene-octene random copolymer or styrene-ethylene-butene block copolymer.

The aforementioned component (A) is a copolymer of ethylene and propylene which are non-soluble in any solvent at room temperature. Particularly, it is preferred to use a copolymer in which a thermoplastic elastomer wherein ethylene and propylene are randomly bonded is present in the form of a domain, in a matrix of propylene polymer. It is preferred that the content of ethylene is 20˜30 mole %, the melt index measured by the method of ASTM D-1235 is 15˜30 g/10 minutes, more preferably 20˜25 g/10 minutes, the density measured by the method of ASTM D-1606 is 0.890˜0.900 g/cm³. The ethylene content of less than 20 mole % will result in poor flexibility, and if the ethylene content exceeds 30 mole %, there are problems in that it will be impossible to make a commercial product therefrom, and also be impossible to operate press-coating process because the tension becomes too high in a melt state. If the melt index is less than 15 g/10 minutes, the drawability during the press-coating process becomes bad which leads to a poor processibility. On the other hand, when the melt index is more than 30 g/10 minutes, the product loss increases because of the high neck-in and further, there is also a disadvantage in that the melt-kneading with the component (B) becomes difficult. Therefore, it is preferred to use ethylene-propylene copolymer having the aforementioned properties.

The component (B) is an ethylene-octene random copolymer or a styrene-ethylene-butene block copolymer. The ethyelene-octene random copolymer is a thermoplastic elastomer wherein ethylene and octene are randomly bonded and having ethylene content of 60˜90 parts by weight, octene content of 10˜40 parts by weight, and pattern viscosity of 1.5˜10 at ML 1+4 (121° C.). Especially, it is preferred that the pattern viscosity is in the range of 3˜8. This is because that there is no commercial product having pattern viscosity of less than 1.5, and in case that the pattern viscosity is less than 1.5, the hardness is too high and by which the flexibility will be lowered. When the pattern viscosity is more than 10, the melt-kneading with the component (A) becomes difficult and it also lowers the drawability thereof.

The styrene-ethylene-butene block copolymer among the component (B) is a ternary copolymer which is obtained by adding hydrogen to a butadiene polymer block which is copolymerized with a styrene-polymer block and forming an ethylene block in a portion thereof. The preferred pattern viscosity is 1˜18 and more preferably, 1.5˜12. When the pattern viscosity is less than 1.0, the hardness is too high to secure a good flexibility and if the pattern viscosity exceeds 18, it becomes difficult to conduct a melt-kneading with the component (A) and the drawability will be also decreased.

The resin composition of the press-coating of the present invention comprises 60˜95 parts by weight, preferably 65˜90 by weight of the component (A) and 40˜5 parts by weight, preferably 35˜10 parts by weight of the component (B). When the amount of the component (A) is less than 60 parts by weight and the amount of the component (B) is more than 40 parts by weight, the drawability lowers which in turn makes it difficult to conduct a press-process. On the other hand, when the amount of the component (A) is more than 95 parts by weight and the amount of the component (B) is less than 5 parts by weight, there is a problem in that the flexibility is remarkably decreased.

The resin composition for press-coating of the present invention may further comprise various additives in addition to the above components (A) and (B) as long as such additives do not affect the object of the present invention. For example, it is possible to add an organic or inorganic filler, a flame retardant, an UV-stabilizer, an antistatic agent, an organic or inorganic coloring agent, etc. with an appropriate usage.

The resin composition for press-coating comprising aforementioned additives can be prepared by widely known kneading process wherein the components are kneaded in melt state. Specifically, the process is carried out by using kneader, uniaxial extruder, biaxial extruder, static-mixer, etc. Where appropriate, It is also possible to dry-blend each components and formulate when molding the same.

In the tarpaulin of the present invention, it is the polypropylene woven fabric on which the aforementioned composition for press-coating is press-coated. Said polypropylene woven fabric is a woven fabric of multifilament yarn made from single polymer of propylene. In the present invention, multifilament yarn having tensile strength of 3.5˜4 g/D which is used for preparing bag, backpack, shoe-laces, etc. is not used but multifilament yarn having tensile strength of 6.5˜7 g/D is used in order to make it possible to be useful as industrial material.

In the case wherein the above multifilament yarn is used for preparing polypropylene woven fabric, it is possible to further add an antioxidant, an UV-stabilizer, a flame retardant, an antistatic agent, or an organic or inorganic coloring agent, etc. depending upon the appropriate use thereof.

The tarpaulin using the aforementioned resin composition for press-coating and polypropylene woven fabric is obtained by melting and kneading the resin composition for press-coating with an extruder, and at the same time, by applying only predetermined amount of the resin composition to the both sides of polypropylene woven fabric, then press-coating the same. Herein, the temperature at the time of press-coating should not be less than the melting point of the composition. Specifically, it is necessary to conduct the press-coating at the temperature of at least 200° C., preferably 250˜300° C., based on the temperature of die.

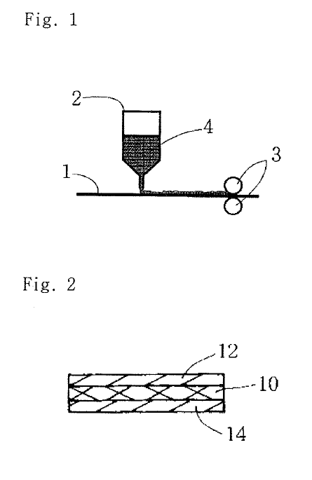

While it is general to coat the resin composition for press-coating on both sides of the polypropylene woven fabric (FIG. 1), it is also possible to apply the resin composition only on a single side, if necessary. Further, in case for preparing a thick tarpaulin, it is possible to coat the resin composition on the same side repeatedly, according to a need. If necessary, an embossing treatment can be conducted simultaneously with the application of the resin composition by using a chilling role on which various embossing patterns are carved.

To further illustrate this invention, and not by way of limitation, the following examples are given.

### EXAMPLES 1 TO 4 AND COMPARATIVE EXAMPLES 1 AND 2

As shown in Table 1, in Examples 1 to 4 of the present invention, the components (A) and (B) were weighed and blended in a dry mixer (Volender mixer) and supplied to a hopper of an uniaxial extruder equipped with a T-die. As soon as the mixture which was melt-kneaded in the extruder was discharged from the T-die in a melt state, polypropylene woven fabric was coated with the above extruded mixture and simultaneously cooled by using a chill role, and then transported to the secondary extruder connected in on-line. The melt extruded mixture was also coated on the opposite side of the polypropylene woven fabric in the same manner. The configuration of the uniaxial extruder enabled a dual control of temperature. The temperature range was 180˜260° C. and the T-die was consisted of 7 portions and the temperature range thereof was 280˜300° C.

The tensile strength and disruptive strength of the such obtained tarpaulin were measured according to the method of KS K0520 and KskO536 and the results are shown in the following Table 2.

TABLE 1

| | Component A¹⁾ | Component A²⁾ | Polypropylene |
|---|---|---|---|
| | (parts by weight) | (parts by weight) | Woven fabric |
| Example 1 | 90 | 10 | F-1³⁾ |
| Example 2 | 80 | 20 | F-1 |
| Example 3 | 70 | 30 | F-1 |
| Example 4 | 90 | 10 | F-1⁴⁾ |

| | |
|---|---|
| Comparative | PET woven fabric (the form of PET woven fabric used in |
| Example 1 | the PVC tarpaulin): 1000 D × 1000 D, 9 × 9/in² |
| Comparative | PET woven fabric (the form of PET woven fabric used in |
| Example 2 | the PVC tarpaulin): 500 D × 500 D, 16 × 16/in² |

¹⁾Ethylene-propylene copolymer having an ethylene content of 25 mole %, a density of 0.890 g/cm³ and a melt-flow index of 25 g/10 minutes (measured at 230° C. 2.18 kg)
²⁾Styrene-ethylene-butene block copolymer having a pattern viscosity of ML 1 + 4 (121° C.)
³⁾Polypropylene woven fabric made from multifilament yarn having a tensile strength of 6.7 g/D, with the form of 1000 D × 1000 D, 16 × 16/in²
⁴⁾Polypropylene woven fabric made from multifilament yarn having a tensile strength of 6.7 g/D, with the form of 1500 D × 1500 D, 14 × 14/in²

TABLE 2

| | Tensile strength | | Disruptive | | | |
|---|---|---|---|---|---|---|
| | (kgf) | | Strength (kgf) | | Thickness | Weight |
| | warp | woof | warp | Woof | (mm) | (g/m²) |
| Ex. 1 | 170 | 100 | 20 | 16 | 0.59 | 360 |
| Ex. 2 | 160 | 100 | 25 | 20 | 0.55 | 340 |
| Ex. 3 | 170 | 100 | 14 | 16 | 0.65 | 450 |
| Ex. 4 | 180 | 120 | 50 | 45 | 0.75 | 450 |
| Comp Ex. 1 | 140 | 120 | 30 | 25 | 0.43 | 480 |
| Comp Ex. 2 | 120 | 110 | 20 | 15 | 0.65 | 750 |

As explained above, the tarpaulin of the present invention as obtained by using a resin composition for press-coating is flexible, light and recyclable. Because the tarpaulin of the present invention has an excellent mechanical strength, it is suitable for use as an industrial material.

What is claimed is:

1. A tarpaulin comprising:
a polypropylene woven fabric layer prepared by weaving polypropylene multifilament yarn; and
a resin composition layer which is press-coated on either or both sides of said polypropylene woven fabric layer, wherein the resin composition is obtained by melt-kneading ethylene-propylene copolymer and ethylene-octene random copolymer or styrene-ethylene-butene block copolymer.

2. The tarpaulin according to claim 1, wherein said resin composition layer is obtained by melt-kneading 60˜95 parts by weight of ethylen-propylene copolymer and 5˜40 parts by weight of ethylene-octene random copolymer or styrene-ethylene-butene block copolymer.

3. The tarpaulin according to claim 1 or claim 2, wherein said ethylene-propylene copolymer satisfies the following condition:
1) ethylene content: 20˜30 mole %;
2) melt index: 15˜30 g/10 minutes
3) density: 0.890˜0.900 g/cm³.

4. The tarpaulin according to claim 1 or claim 2, wherein said ethylene-octene random copolymer satisfies the following condition:
1) ethylene content: 60˜90 parts by weight;
2) octene content : 40˜10 parts by weight
3) pattern viscosity: 1.5˜10 at ML 1+4 (121° C.)

5. The tarpaulin according to claim 1 or claim 2, wherein said styrene-ethylene-butene block copolymer satisfies the following condition:
1) pattern viscosity: 1.0˜18 at ML 1+4 (121° C.)

6. The tarpaulin according to claim 1, wherein the tensile strength of said multifilament yarn is 6.5˜7 g/D.

7. A process for preparing a tarpaulin, comprising the steps of:
1) preparing polypropylene woven fabric by weaving polypropylene multifilament yarn; and
2) applying a resin composition obtained by melt-kneading ethylene-propylene copolymer and ethylene-octene random copolymer or styrene-ethylene-butene copolymer on either or both sides of said polypropylene woven fabric and extruding by an extruder.
